(19) United States
(12) Patent Application Publication
(10) Pub. No.: US 2025/0184360 A1
(43) Pub. Date: Jun. 5, 2025

(54) PERFORMING FINGERPRINT-BASED DATA LOSS PREVENTION (DLP) USING INFORMATION OBTAINED FROM CLOUD-NATIVE SERVICES

(71) Applicant: Fortinet, Inc., Sunnyvale, CA (US)

(72) Inventors: John A. Headley, Irvine, CA (US); Ayan Ray, Carlsbad, CA (US)

(73) Assignee: Fortinet, Inc., Sunnyvale, CA (US)

(21) Appl. No.: 18/525,623

(22) Filed: Nov. 30, 2023

(51) Int. Cl. H04L 9/40; G06F 21/62

(52) U.S. Cl. CPC H04L 63/20; G06F 21/6218; H04L 63/10

(57) ABSTRACT

Systems and methods for performing fingerprint-based data loss prevention (DLP) using information obtained from a cloud-native service are provided. In one example, DLP fingerprints are obtained by a security enforcement system (e.g., a network security appliance, a secure access service edge (SASE) platform, or a security service edge (SSE)). The DLP fingerprints may be generated locally by the security enforcement system or generated remotely from the security service edge based on a set of files stored in a cloud-native service, representing, for example, infrastructure-as-a-service (IaaS) (e.g., an object storage service) or Software-as-a-service (SaaS) (e.g., a file hosting service or a productivity platform). Based at least in part on the DLP fingerprints, DLP is performed on a file by a DLP service of the security enforcement system, in which the file is at rest on an endpoint protected by the security enforcement system or in transit through the security enforcement point.

### BACKGROUND

### Field

Various embodiments of the present disclosure generally relate to data loss prevention (DLP). In particular, some embodiments relate to facilitating the performance of fingerprint-based DLP by a security enforcement point (e.g., a network security appliance, a secure access service edge (SASE) platform, a security service edge (SSE) platform, or the like) using information obtained from cloud-native services (e.g., infrastructure-as-a-service (IaaS), Software-as-a-service (SaaS), platform-as-a-service (PaaS), and/or container-as-a-service (CaaS)).

### Description of the Related Art

Data loss prevention (DLP) is technology that aims to ensure sensitive data is not “lost” (e.g., transmitted/transferred from a secure location to an insecure location). Data that is being transmitted between two locations is commonly referred to as data in transit (as compared to data at rest). This can either come from intentional or malicious attempts to move data, or inadvertently transmitting data without knowing potential consequences. A security enforcement point may provide DLP functionality to detect sensitive files in transit or at rest, for example, so they can be blocked or monitored. Examples of two underlying technical methods/technologies that may be used to identify what files are considered sensitive to a particular organization include pattern matching (e.g., regex pattern matching) and file fingerprinting.

Pattern matching involves an administrator defining a pattern (e.g., in a formal syntax to define a pattern or match condition), for example, in the form of a regular expression and the security enforcement point scanning the contents of a file in transit (e.g., as part of network traffic attempting to traverse the security enforcement point) for a matched pattern of data.

File fingerprinting involves an administrator providing or defining a set of one or more files, for example, based on a location (e.g., one or more folders, directories, or file shares) in which they are stored. The files stored in the specified location can then be used as a basis to generate DLP fingerprints, for example, periodically, on demand, and/or responsive to a trigger event (e.g., the addition of a new file to the specified location). A “DLP fingerprint” or simply a “fingerprint” is a hash value of the data in the file (typically, not a single hash value of the entire file, but rather several hashes taken of chunks/segments of the file). The security enforcement point may then take these fingerprints and scan the contents of a file in transit for a matched hash of data.

### SUMMARY

Systems and methods are described for performing fingerprint-based DLP using information obtained from a cloud-native service. According to one embodiment, DLP fingerprints are obtained by a security enforcement system. The DLP fingerprints are generated based on a set of files stored in a cloud-native service. DLP is performed on a file by a data loss prevention (DLP) service of the security enforcement system based at least in part on the DLP fingerprints, in which the file is at rest on an endpoint protected by the security enforcement system or in transit through the security enforcement point.

Other features of embodiments of the present disclosure will be apparent from accompanying drawings and detailed description that follows.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 is a block diagram illustrating an operating environment in which various embodiments of the present disclosure may be employed.

FIG. 2 is a high-level flow diagram illustrating a set of operations for performing fingerprint-based DLP using information obtained from cloud-native services in accordance with an embodiment of the present disclosure.

FIG. 3 is a flow diagram illustrating a set of operations for performing DLP fingerprint generation and delivery in accordance with an embodiment of the present disclosure.

FIG. 4 is a flow diagram illustrating a set of operations for performing DLP scanning in accordance with an embodiment of the present disclosure.

FIG. 5 illustrates an example computer system in which or with which embodiments of the present disclosure may be utilized.

### DETAILED DESCRIPTION

Systems and methods are described for performing fingerprint-based DLP using information obtained from a cloud-native service. Existing security enforcement points (e.g., network security appliances, SASE platforms, SSE platforms, and the like) limit file fingerprinting to two sources for files-manually through administrator-submitted files and dynamically through connections (e.g., using a communication protocol like server message block (SMB)) to on-premises file shares. One problem with this these current file fingerprinting source limitations is at least some portion of organizations' sensitive files are located in cloud-native services, but the security enforcement point cannot dynamically fingerprint files in the cloud for use in DLP, for example, by interacting with the cloud-native storage protocols/APIs, such as object storage. As a result, DLP (based on the current implementation of DLP fingerprinting with its fingerprinting source limitations), is increasingly not useful or scalable, both from the security administration perspective in identifying what is sensitive or not, and then creating the appropriate rules to guard that data. Meanwhile, it is expected that organizations will continue to move their existing file shares to cloud-native services (e.g., IaaS, SaaS, PaaS, and CaaS) and/or create new file shares directly in cloud-native services, thereby exacerbating the problem. Non-limiting examples of cloud-native services in which files may be stored include IaaS cloud storage services (e.g., Azure storage, Azure blob storage, Amazon Web Services (AWS) simple storage service (S3) (or other object storage)), SaaS productivity solutions (e.g., Microsoft 365), and SaaS file hosting services (e.g., Dropbox and Box).

Embodiments described herein seek to address or at least mitigate the limitations mentioned above by allowing a security enforcement point to obtain fingerprints generated based on files stored within predefined or configurable areas of cloud-native services (e.g., cloud directories/paths/folders/file shares, object storage, and the like). For example, the administrator of the API-based CASB product may define specific cloud directories/folders/file shares, storage accounts, containers within a storage account, simple storage service (S3) buckets, and/or the like) that should be monitored/included for the purpose of DLP fingerprinting. The CASB product may then periodically or in real time provide updated DLP fingerprints to the security enforcement point for use by DLP functionality of the security enforcement point (e.g., a SASE platform) and/or for use by DLP functionality of another security enforcement point (e.g., a network security appliance) to which the security enforcement point further propagates the DLP fingerprints.

While various examples herein are described with reference to a SASE platform applying DLP fingerprints received from a CASB that were generated based on files stored within a cloud-native service, it is to be appreciated various other security enforcement points (e.g., network security appliances, such as a firewall or an email security appliance, and SSE platforms) may obtain such DLP fingerprints directly or indirectly from the CASB that are generated by the CASB or by the cloud-native service. Additionally, in other examples, the SASE platform may have connectivity with the cloud-native service so as to allow it to generate the DLP fingerprints or received them from the cloud-native service.

In the following description, numerous specific details are set forth in order to provide a thorough understanding of embodiments of the present disclosure. It will be apparent, however, to one skilled in the art that embodiments of the present disclosure may be practiced without some of these specific details. In other instances, well-known structures and devices are shown in block diagram form.

### Terminology

Brief definitions of terms used throughout this application are given below.

A “computer” or “computer system” may be one or more physical computers, virtual computers, or computing devices. As an example, a computer may be one or more server computers, cloud-based computers, cloud-based cluster of computers, virtual machine instances or virtual machine computing elements such as virtual processors, storage and memory, data centers, storage devices, desktop computers, laptop computers, mobile devices, or any other special-purpose computing devices. Any reference to “a computer” or “a computer system” herein may mean one or more computers, unless expressly stated otherwise.

The terms “connected” or “coupled” and related terms are used in an operational sense and are not necessarily limited to a direct connection or coupling. Thus, for example, two devices may be coupled directly, or via one or more intermediary media or devices. As another example, devices may be coupled in such a way that information can be passed there between, while not sharing any physical connection with one another. Based on the disclosure provided herein, one of ordinary skill in the art will appreciate a variety of ways in which connection or coupling exists in accordance with the aforementioned definition.

If the specification states a component or feature “may”, “can”, “could”, or “might” be included or have a characteristic, that particular component or feature is not required to be included or have the characteristic.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

The phrases “in an embodiment,” “according to one embodiment,” and the like generally mean the particular feature, structure, or characteristic following the phrase is included in at least one embodiment of the present disclosure, and may be included in more than one embodiment of the present disclosure. Importantly, such phrases do not necessarily refer to the same embodiment.

As used herein, a “network security appliance” or a “network security device” generally refers to a device or appliance in virtual or physical form that is operable to perform one or more security functions. A network security device may reside within the particular network that it is protecting, or network security may be provided as a service with the network security device residing in the cloud. Some network security devices may be implemented as general-purpose computers or servers with appropriate software operable to perform one or more security functions. Other network security devices may also include custom hardware (e.g., one or more custom Application-Specific Integrated Circuits (ASICs)). For example, while there are differences among network security device vendors, network security devices may be classified into three general performance categories, including entry-level, mid-range, and high-end network security devices. Each category may use different types and forms of central processing units (CPUs), network processors (NPs), and content processors (CPs). NPs may be used to accelerate traffic by offloading network traffic from the main processor. CPs may be used for security functions, such as flow-based inspection and encryption. Entry-level network security devices may include a CPU and no co-processors or a system-on-a-chip (SoC) processor that combines one or more CPUs, CPs, NPs. Mid-range network security devices may include one or more multi-core CPUs, one or more separate NP Application-Specific Integrated Circuits (ASICs), and one or more separate CP ASICs. At the high-end, network security devices may have multiple NPs and/or multiple CPs. A network security device is typically associated with a particular network (e.g., a private enterprise network) on behalf of which it provides one or more security functions. Non-limiting examples of security functions include authentication, next-generation firewall protection, antivirus scanning, content filtering, data privacy protection, web filtering, network traffic inspection (e.g., secure sockets layer (SSL) or Transport Layer Security (TLS) inspection), intrusion prevention, intrusion detection, denial of service attack (DoS) detection and mitigation, encryption (e.g., Internet Protocol Secure (IPSec), TLS, SSL), application control, Voice over Internet Protocol (VOIP) support, Virtual Private Networking (VPN), data loss prevention (DLP), antispam, antispyware, logging, reputation-based protections, event correlation, network access control, vulnerability management, and the like. Such security functions may be deployed individually as part of a point solution or in various combinations in the form of a unified threat management (UTM) solution. Non-limiting examples of network security appliances/devices include network gateways, VPN appliances/gateways, UTM appliances (e.g., the FORTIGATE family of network security appliances), messaging security appliances (e.g., FORTIMAIL family of messaging security appliances), database security and/or compliance appliances (e.g., FORTIDB database security and compliance appliance), web application firewall appliances (e.g., FORTIWEB family of web application firewall appliances), application acceleration appliances, server load balancing appliances (e.g., FORTIBALANCER family of application delivery controllers), network access control appliances (e.g., FORTINAC family of network access control appliances), vulnerability management appliances (e.g., FORTISCAN family of vulnerability management appliances), configuration, provisioning, update and/or management appliances (e.g., FORTIMANAGER family of management appliances), logging, analyzing and/or reporting appliances (e.g., FORTIANALYZER family of network security reporting appliances), bypass appliances (e.g., FORTIBRIDGE family of bypass appliances), Domain Name Server (DNS) appliances (e.g., FORTIDNS family of DNS appliances), wireless security appliances (e.g., FORTIWIFI family of wireless security gateways), virtual or physical sandboxing appliances (e.g., FORTISANDBOX family of security appliances), and DOS attack detection appliances (e.g., the FORTIDDOS family of DOS attack detection and mitigation appliances).

As used herein, “data loss prevention” or “DLP” generally refers to a cybersecurity solution that detects and prevents any unauthorized data movement (e.g., extraction of sensitive data). DLP functionality may be implemented within a network security appliance and/or provided as a service as part of a SASE or SSE solution. DLP technology may make use of various methods (e.g., pattern matching, regex pattern matching, and/or file fingerprinting) to identify what files are considered sensitive to the particular organization. As those skilled in the art will appreciate, data leak prevention is subtly different from data loss prevention; however, for the purposes of this disclosure data leak prevention is considered to be the same as DLP and these terms should be considered interchangeable herein. Embodiments described herein are generally concerned with the generation, distribution, and application of file fingerprinting (which may be referred to herein as performing DLP and/or performing DLP scanning).

As used herein, a “security enforcement point” or a “security enforcement system” generally refers to a specific device, system, or location that is responsible for enforcing security policies and/or controls. Non-limiting examples of a security enforcement point or system include network security appliances, SASE platforms, SSE platforms, and the like.

As used herein, “secure access service edge” or “SASE” generally refers to a cloud-based security architecture that addresses the challenges of cloud computing, remote work, and cyberthreats by unifying software-defined networking and security services (e.g., security-as-a-service functions). SASE functionality is typically delivered as a cloud service, improves security by adopting the zero-trust model, simplifies information technology (IT) management by eliminating the need for on-premises hardware and complex infrastructure, and saves money by reducing the costs of traditional security solutions. The cloud-delivered security service is located between the remote endpoints and any networks those endpoints access, regardless of the location of the remote endpoints: essentially, moving the security to the cloud and delivering secure access from anywhere. One goal of a SASE platform is to help ensure scalable, reliable, centralized, policy-based management. SASE platforms bolster edge security and resilience at a time when hybrid work, internet of things (IoT), artificial intelligence (AI) and other trends are expanding the attack surface and creating additional risk of cyberattacks and significant business disruptions. SASE may combine cloud-based software-defined wide area networking (SD-WAN) and security service edge (SSE) to connect and protect users from the network edge to anywhere. SASE typically unites networking and security and supports secure access to the web, cloud, and applications. The SASE architecture focuses on using a cloud-delivered security service that enforces secure access at the farthest edge of the network, namely, at the service edge or at the user endpoints. This architecture generally has the following goals: (i) achieve secure Internet access for endpoints that connect to a cloud-delivered security service that comes between a user and the Internet; (ii) reduce latency by having endpoints connect to a cloud-delivered security service's closest point of presence (PoP); (iii) Meet endpoints' traffic demand by providing a cloud-delivered security service that can scale dynamically; (iv) reduce congestion by distributing endpoint traffic to different PoPs with sufficient geographical spread and avoiding a single point required for traffic flow; and (v) enforce a zero trust model to provide protected network access for endpoints. A non-limiting example of a SASE platform is FORTISASE, available from Fortinet, Inc. of Sunnyvale, CA, which includes the following components that run on one operating system and are manageable using a single console: an artificial intelligence (AI)-powered secure web gateway (SWG), zero-trust network access (ZTNA), a cloud access security broker (CASB), firewall-as-a-Service (FWaaS), and secure SD-WAN. In operation, an endpoint or branch may redirect its traffic to the cloud, data center, or software-as-a-service (SaaS) to pass through an FWaaS, or an SWG where the traffic is subject to security policies and advanced threat protection measures. For traffic redirection, remote users' endpoints may rely on a software agent, while devices and branches may rely on a thin edge device. CASB and ZTNA services may also be used within the SASE architecture to restrict access to cloud/SaaS and data centers, respectively. In the SASE architecture, WAN capabilities from the branch to a cloud-delivered security service or from within the cloud-delivered service itself can use a variety of WAN technologies, with SD-WAN currently being at the forefront of those technologies.

As used herein, a “security service edge” or “SSE” generally refers to a convergence of network security services that are delivered from a purpose-build cloud platform to provide secures access to the web, cloud services and private applications. SSE capabilities typically include access control, threat protection, data security, security monitoring, and acceptable-use control enforced by network-based and application programming interface (API)-based integration. The role of SSE is to provide an organization with a full set of security technologies to provide employees, trusted partners and contractors with secure remote access to applications (e.g., software-as-a-service (SaaS) applications and private applications), data, tools, and other corporate resources, and monitor and track behavior once users access the network.

As used herein, a “cloud” or “cloud environment” broadly and generally refers to a platform through which cloud computing may be delivered via a public network (e.g., the Internet) and/or a private network. The National Institute of Standards and Technology (NIST) defines cloud computing as “a model for enabling ubiquitous, convenient, on-demand network access to a shared pool of configurable computing resources (e.g., networks, servers, storage, applications, and services) that can be rapidly provisioned and released with minimal management effort or service provider interaction.” P. Mell, T. Grance, The NIST Definition of Cloud Computing, National Institute of Standards and Technology, USA, 2011. The infrastructure of a cloud may be deployed in accordance with various deployment models, including private cloud, community cloud, public cloud, and hybrid cloud. In the private cloud deployment model, the cloud infrastructure is provisioned for exclusive use by a single organization comprising multiple consumers (e.g., business units), may be owned, managed, and operated by the organization, a third party, or some combination of them, and may exist on or off premises. In the community cloud deployment model, the cloud infrastructure is provisioned for exclusive use by a specific community of consumers from organizations that have shared concerns (e.g., mission, security requirements, policy, and compliance considerations), may be owned, managed, and operated by one or more of the organizations in the community, a third party, or some combination of them, and may exist on or off premises. In the public cloud deployment model, the cloud infrastructure is provisioned for open use by the general public, may be owned, managed, and operated by a cloud provider (e.g., a business, academic, or government organization, or some combination of them), and exists on the premises of the cloud provider. The cloud service provider may offer a cloud-based platform, infrastructure, application, or storage services as-a-service, in accordance with a number of service models, including Software-as-a-Service (SaaS), Platform-as-a-Service (PaaS), and/or Infrastructure-as-a-Service (IaaS). In the hybrid cloud deployment model, the cloud infrastructure is a composition of two or more distinct cloud infrastructures (private, community, or public) that remain unique entities, but are bound together by standardized or proprietary technology that enables data and application portability and mobility (e.g., cloud bursting for load balancing between clouds).

As used herein, a “cloud service provider” or a “cloud provider” generally refers to the owner, manager, and/or operator of a cloud or cloud platform. A cloud provider may be a business, academic, or government organization, or some combination of them. Non-limiting examples of clouds or cloud platforms and their respective cloud providers include Azure provided by Microsoft, Google Cloud Platform (GCP) provided by Google, Amazon Web Services (AWS) provided by Amazon, Oracle Cloud Infrastructure provided by Oracle, and IBM Cloud provided by IBM.

### Example Operating Environment

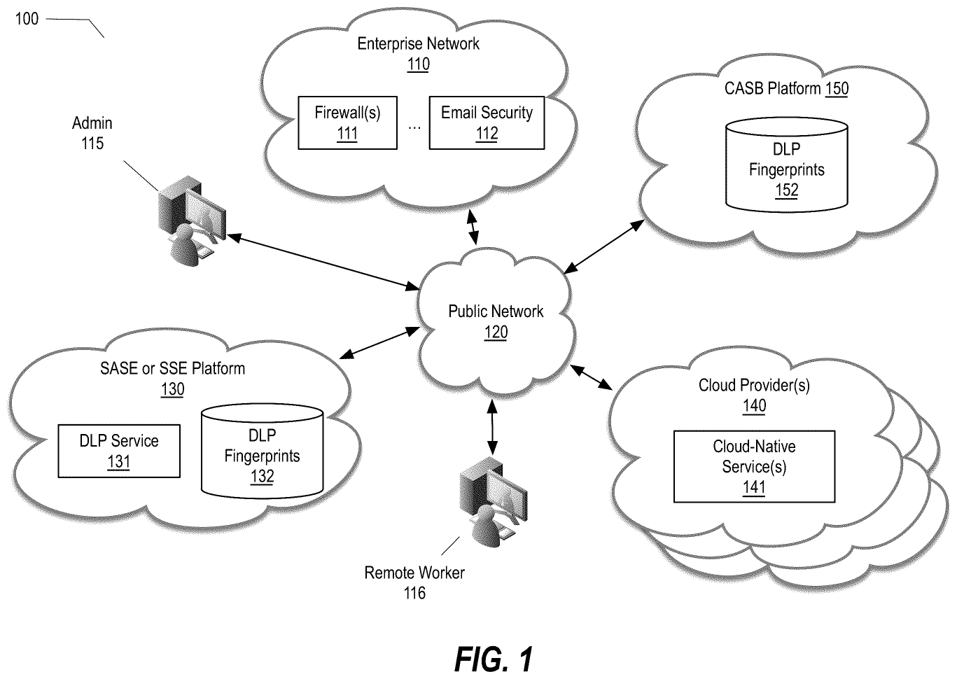

FIG. 1 is a block diagram illustrating an operating environment 100 in which various embodiments of the present disclosure may be employed. In the context of the present example, a public network 120 (e.g., the Internet) is shown connecting an enterprise network 110, a SASE or SSE platform 130, one or more cloud provider(s) 140, a CASB platform 150, a remote worker 116, and an administrative user 115 in communication. In one embodiment, the SASE or SSE platform 130, the CASB platform 150, and one or more network security appliances associated with the enterprise network 110 may communicate with each other via an API connection or a telemetry connection (e.g., the Fortinet Security Fabric available from Fortinet, Inc. of Sunnyvale, CA), for example, that might be part of a cybersecurity mesh architecture (CSMA) in which various cybersecurity products/solutions/tools achieve a more integrated security policy by facilitating interoperability and communication among the various cybersecurity products/solutions/tools.

The enterprise network 110 may represent one or more on-premise data centers that are owned and operated by an organization, one or more colocation facilities, one or more data centers managed by a third party (or a managed service provider) on behalf of the organization, which may lease the equipment and infrastructure, and/or a combination thereof. The enterprise network 110 is shown including one or more firewalls 111 and one or more email security appliances 112, representing non-limiting examples of network security appliances that may include, among other things, DLP functionality to protect against exfiltration of sensitive data from the enterprise network 110.

The cloud provider(s) 140 may include operators (e.g., Microsoft, Google, Amazon, Oracle, and IBM) of cloud platforms (e.g., Azure, GCP, AWS, Oracle Cloud Infrastructure, and IBM Cloud, respectively), which may host various cloud-native services (e.g., cloud-native service(s) 141). Non-limiting examples of cloud-native service(s) 141 include IaaS cloud storage services (e.g., Azure storage, Azure blob storage, AWS S3 (or other object storage), SaaS productivity solutions (e.g., Microsoft 365), and SaaS file hosting services (e.g., Dropbox and Box). As noted above, organizations are increasingly making use of cloud-native services to store files in cloud directories/folders/file shares, storage accounts, containers within a storage account, S3 buckets, and the like). In the context of the present example, it is assumed at least some portion of files (not shown) utilized by the enterprise are stored in one or more of the cloud-native service(s) 141 and at least some portion of those files contain sensitive data, thereby making them useful for generation of DLP fingerprints.

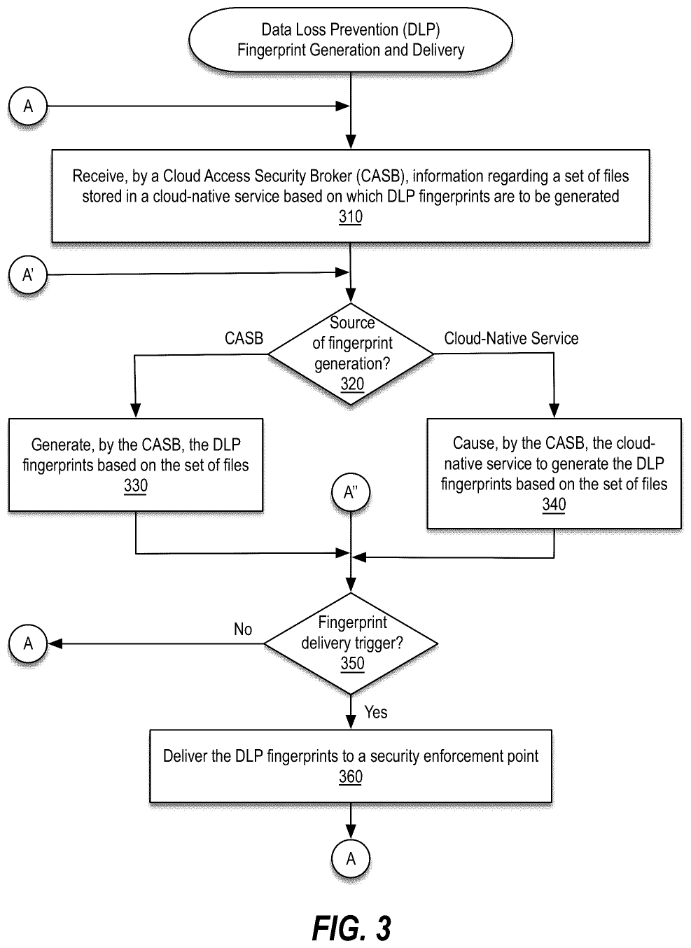

CASB platforms (e.g., CASB platform 150) represent a type of security solution that helps protect cloud-hosted services. CASB platforms are generally responsible for monitoring and controlling data sent between an associated enterprise network (e.g., enterprise network 110) and the cloud (e.g., cloud-native service(s) 141). For example, CASB platforms may be deployed to help ensure regulatory compliance and data protection, govern cloud usage across devices and cloud applications, and protect against threats. CASB platform 150 may be configured via API integration with one or more cloud-native services (e.g., cloud-native service(s) 141) to monitor defined cloud storage and maintain a set of DLP fingerprints (e.g., DLP fingerprints 152) in a fingerprint database. In one embodiment, API integration may include the administrative user 115 configuring the CASB platform 150, via a user interface associated with the CASB platform 150, a command-line interface (CLI) of the CASB platform 150, and/or an API exposed by the CASB platform 150. For its part, the CASB platform 150 may periodically monitor the specified file storage locations and generate DLP fingerprints as new files are added or on demand, for example, responsive to a request by the administrative user 115. In various examples described herein, the DLP fingerprints generated by the CASB platform 150 (or on behalf of the CASB platform 150 by a given cloud-native service capable of generating DLP fingerprints) may be provided directly or indirectly to one or more security enforcement points (e.g., firewalls 111, email security appliances 112 and/or SASE or SSE platform 130) for their use in performing DLP scanning. A non-limiting example of DLP fingerprint generation and delivery is described further below with reference to FIG. 3.

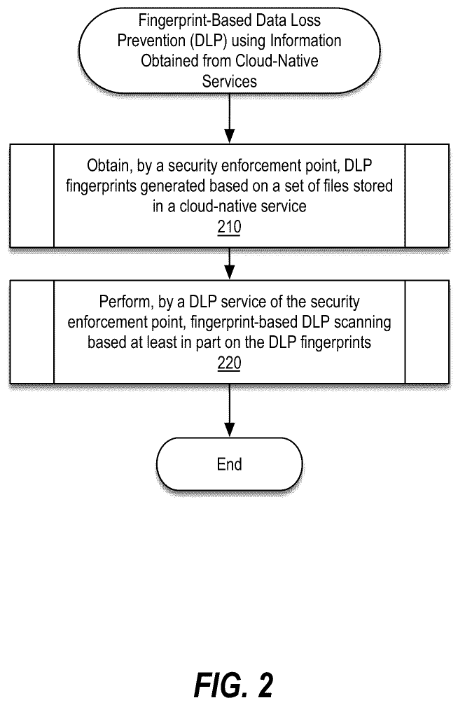

The SASE or SSE platform 130 may represent a set of cloud-based networking and security services (including a DLP service 131) responsible for, among other things, providing remote workers (e.g., remote worker 116) of the enterprise that use off-net endpoints (e.g., the laptop computer, desktop computer, tablet computer, smartphone, and/or the like utilized by remote worker 116) as well as local workers or users that use on-net endpoints within the enterprise network 110 with secure access to resources associated with the enterprise network 110 and protecting all users against uploading or downloading files containing sensitive data based on DLP scanning, for example, that may be performed on files attempting to traverse the SASE or SSE platform 130 by the DLP service 131 based on a set of DLP fingerprints (e.g., DLP fingerprints 132), for example, maintained within a local fingerprint database. Notably, in various embodiments described herein, the set of DLP fingerprints are not limited to those traditionally available in which the source of the files a set of one or more files manually provided by an administrative user (e.g., the administrative user 115) and/or specified based on their location within on-premises file shares. Rather, the set of DLP fingerprints may include DLP fingerprints dynamically generated based on information obtained from one or more cloud-native services (e.g., cloud-native service(s) 141). For example, as noted above CASB platform 150 may be configured via API integration with the one or more cloud-native services to monitor defined cloud storage and maintain DLP fingerprints 152 generated by the CASB platform 150 itself or by one or more cloud-native services of the cloud-native services 141 having such capabilities. As described further below, the DLP fingerprints 152 (or a subset of those that have been newly generated) may be provided periodically, on demand, or in real time to the SASE or SSE platform 130. Alternatively, the SASE or SSE platform 130 may be configured via API integration with one or more of the cloud-native service(s) 141 to allow the SASE or SSE platform to directly monitor defined cloud storage and generate and maintain the DLP fingerprints 132. Regardless of the source of the DLP fingerprints (e.g., the CASB platform 150, one or more of the cloud-native service(s) 141, or the SASE or SSE platform 130), in various examples described herein, the SASE or SSE platform 130 now has the ability to perform fingerprint-based DLP using information obtained from cloud-native services, thereby maintaining the usefulness and the scalability of the DLP scanning performed by the SASE or SSE platform 130. A non-limiting example of fingerprint-based DLP using information obtained from cloud-native services is described further below with reference to FIG. 2.

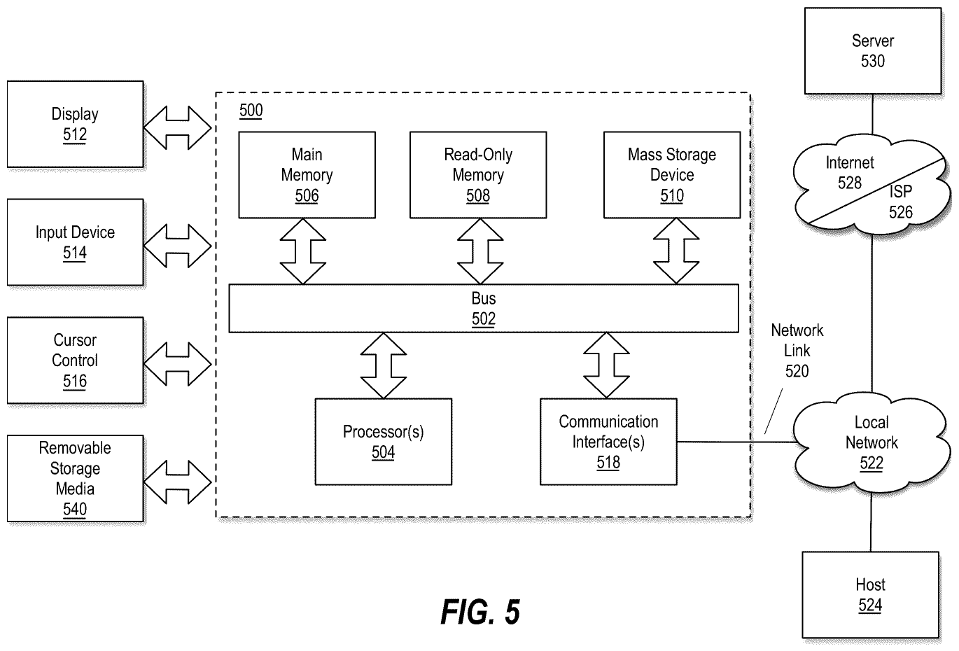

The various platforms, services, and security enforcement points described herein, and the processing described below with reference to the flow diagrams of FIGS. 2-4 may be implemented in the form of executable instructions stored on a machine readable medium and executed by one or more processing resources (e.g., one or more microcontrollers, one or more microprocessors, one or more central processing unit core(s), one or more application-specific integrated circuit (ASIC), one or more field programmable gate array (FPGA), and the like) and/or in the form of other types of electronic circuitry. For example, the processing may be performed by one or more virtual or physical computer systems of various forms, such as the computer system described with reference to FIG. 5 below.

While in the context of the present example, the admin 115 is shown off-net, it is to be appreciated the admin 115 may be located on the enterprise network 110 or on-net. Similarly, while protection of remote worker 116 is described, it is also to be appreciated on-net workers/users (e.g., those within the enterprise network 110) may also be protected. While not shown in the present example, it also to be appreciated DLP functionality (e.g., DLP fingerprints and a DLP service) may be implemented within the CASB platform 150, the firewall(s) 111 and/or the email security appliance 112. Finally, although, the CASB platform 150 is shown separate from the SASE or SSE platform 130, it is to be appreciated the CASB platform 150 may be a component of the SASE or SSE platform 130.

### Example Fingerprint-Based DLP

FIG. 2 is a high-level flow diagram illustrating a set of operations for performing fingerprint-based DLP using information obtained from cloud-native services in accordance with an embodiment of the present disclosure. The processing described with reference to FIG. 2 may be performed by a security enforcement point, for example, a network security appliance, such as a firewall (e.g., one or more of firewall(s) 111) or an email security appliance (e.g., email security appliance 112), a SASE platform (e.g., SASE or SSE platform 130), or an SSE platform (e.g., SASE or SSE platform 130).

At block 210, the security enforcement point obtains DLP fingerprints generated based on a set of files stored in a cloud-native service. As noted above, in one embodiment, the security enforcement point or an intermediate platform, for example, a CASB platform (e.g., CASB platform 150) may perform DLP fingerprint generation via API integration with one or more cloud-native services (e.g., cloud-native service(s) 141). For example, an administrative user (e.g., admin 115) may configure the CASB platform to periodically scan one or more cloud directories/folders/file shares, storage accounts, containers within a storage account, simple storage service (S3) buckets, and/or the like associated with the one or more cloud-native services. Depending on the particular implementation, the source of the DLP fingerprints (e.g., DLP fingerprints 132 or 152) may vary. For example, all or some portion of the DLP fingerprints may be received from the CASB platform that generated the DLP fingerprints, from the CASB platform on behalf of which one or more cloud-native services (e.g., cloud-native service(s) 141) generated the DLP fingerprints, and/or received from another security enforcement point that received them from the CASB platform. According to one embodiment, DLP fingerprints may be communicated from one cybersecurity product/solution (e.g., a CASB platform) to another, for example, representing a security enforcement point (e.g., a SASE platform or a network security appliance) or from one security enforcement point to another via push or pull mechanisms (e.g., the source invoking an API method exposed by the destination, the destination invoking an API method exposed by the source, the source proactively delivering updated fingerprints to the destination via a telemetry connection, and/or the destination requesting updated fingerprints from the source via the telemetry connection). Additionally or alternatively, all or some portion of the DLP fingerprints may be generated local to the security enforcement point, for example, by DLP functionality (e.g., DLP service 131) of the security enforcement point via direct API integration with the one or more cloud-native services. A non-limiting example of DLP fingerprint generation and delivery is described further below with reference to FIG. 3.

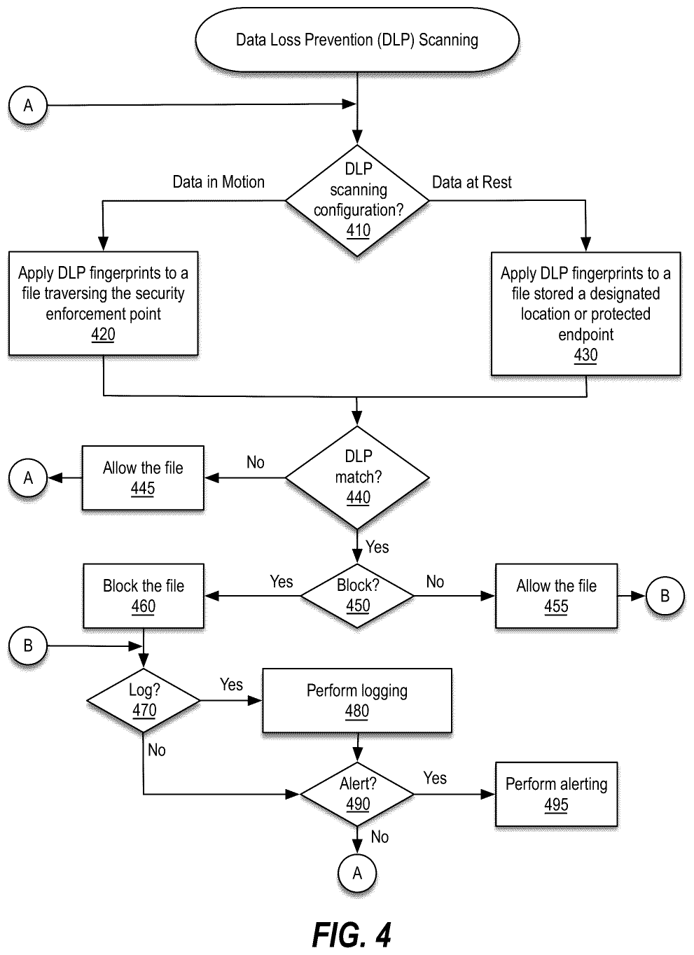

At block 220, fingerprint-based DLP scanning is performed by DLP functionality of the security enforcement point. For example, assuming for sake of illustration the security enforcement point represents a SASE platform (e.g., SASE or SSE platform 130), the fingerprint-based DLP scanning may be performed by a DLP service (e.g., DLP service 131) of the SASE platform based on a locally maintained fingerprint database containing DLP fingerprints (e.g., DLP fingerprints 132). The DLP scanning may be performed on data in motion and/or data at rest. DLP scanning relating to data in motion may be triggered responsive to traffic attempting to traverse the SASE platform including one or more files. DLP scanning relating to data at rest may be triggered on demand (e.g., by an administrative user of the SASE platform or by a user of the endpoint being protected by the SASE platform), on a periodic basis, or in real time, for example, in response to introduction of a new file to the endpoint. A non-limiting example of fingerprint-based DLP scanning is described further below with reference to FIG. 4.

### Example DLP Fingerprint Generation and Delivery

FIG. 3 is a flow diagram illustrating a set of operations for performing DLP fingerprint generation and delivery in accordance with an embodiment of the present disclosure. The processing described with reference to FIG. 3 may be performed by a cybersecurity solution, for example, a CASB platform (e.g., CASB platform 150), a cloud-native service (e.g., one of cloud-native service(s) 141), a security enforcement point, for example, a SASE platform (e.g., SASE or SSE platform 130) or an SSE platform (e.g., SASE or SSE platform 130), and/or a combination of some subset or all the foregoing. For purposes of illustration, in the context of the present example, it is assumed DLP fingerprints are generated by either the CASB platform or the cloud-native service (if it is capable of generating suitable fingerprints).

At block 310, the CASB platform receives information regarding a set of files store in a cloud-native service based on which DLP fingerprints are to be generated. According to one embodiment, the information regarding the set of files may be received from an administrative user (e.g., admin 115). For example, the administrative user may define the set of files based on a location (e.g., one or more cloud directories/folders/file shares, storage accounts, containers within a storage account, S3 buckets, and/or the like) in which the set of files are or will be stored within the cloud-native service.

At decision block 320, assuming a fingerprint generation trigger has occurred (e.g., a request by the administrative user, expiration of a predefined or configurable periodic timer, and/or monitoring of the set of files reveals a new file has been introduced), a determination is made regarding the source of fingerprint generation. If the CASB platform is to perform the fingerprint generation, processing continues with block 330; otherwise, the cloud-native service is to perform the fingerprint generation and processing branches to block 340. Depending on the particular implementation, the determination may be made based on settings configured by the administrative user, dynamically based on capabilities of the cloud-native service, or the determination may be skipped altogether based on the assumption that fingerprint generation is the responsibility of the CASB platform.

At block 330, the CASB platform generates DLP fingerprints based on the set of files. For example, the CASB platform may generate DLP fingerprints for new files introduced to the set of files since the last time DLP fingerprints were generated. Alternatively, the CASB platform may generate DLP fingerprints for the entirety of the set of files. At this point, the CASB platform may locally store the newly generated DLP fingerprints within a local fingerprint database. The DLP fingerprints may be associated with timestamps to facilitate selective distribution of the DLP fingerprints by the CASB platform to one or more security enforcement points. Other non-limiting examples of metadata that may be used for various purposes and that may be included within the DLP fingerprint database include username, user identifier (ID), source IP, source country, cloud service name, cloud-native service specific information, such as tenant ID or Microsoft domain, and device information. A non-limiting usage example for source country, for example, would be only transmitting fingerprints between security enforcement points if the metadata matches an administrator-configured setting (e.g., if the fingerprint was generated for a file uploaded from a specific country or residing only in a specific cloud-native service).

At block 340, the CASB platform requests the cloud-native service to generate DLP fingerprints based on the set of files, for example, invoking an API method exposed by the cloud-native service. As above, DLP fingerprints may be generated for new files introduced to the set of files since the last time DLP fingerprints were generated or DLP fingerprints may be generated for the entirety of the set of files. Upon receipt of the newly generated DLP fingerprints by the CASB platform from the cloud-native service, the CASB platform may locally store the newly generated DLP fingerprints within a local fingerprint database. As above, the DLP fingerprints may be associated with timestamps to facilitate selective distribution of the DLP fingerprints by the CASB platform to one or more security enforcement points.

At decision block 350, it is determined whether a fingerprint delivery trigger has occurred. If so, processing continues with block 360; otherwise, processing may loop back to one of decision block 350, decision block 320, or block 310 to perform a subsequent iteration. Depending on the particular implementation, the fingerprint delivery trigger may represent existence of any new DLP fingerprints since the performance of the last DLP fingerprint delivery, expiration of a predefined or configurable periodic timer, receipt of a request for updated DLP fingerprints from a security enforcement point, and/or receipt of a request to distribute DLP fingerprints from the administrative user.

At block 360, DLP fingerprints (e.g., all or some subset of DLP fingerprints 152) are delivered to one or more security enforcement points. Assuming a request for updated DLP fingerprints was determined to have been received at decision block 350, for example, via a telemetry connection or an API connection with the requestor, those DLP fingerprints generated since the last update may be returned to the requestor, for example, via the telemetry connection or the API connection. Assuming DLP fingerprints are to be pushed (e.g., on demand, responsive to a schedule, or in real time) rather than pulled, a set of updated DLP fingerprints may be determined and distributed to one or more security enforcement points, for example, via a telemetry connection or an API connection with the destination.

While in the context of the present example, it is assumed DLP fingerprints are generated by either a CASB platform or a cloud-native service, it is to be understood in other examples, the DLP fingerprints may be generated by a security enforcement point (e.g., a SASE platform, an SSE platform, or a network security appliance) configured via appropriate API integration with the desired cloud-native services. Furthermore, the cybersecurity solution or security enforcement point that generates the DLP fingerprints based on information obtained from a given cloud-native service or receives the DLP fingerprints from the cybersecurity solution or security enforcement point that generated the DLP fingerprints may or may not perform DLP scanning based on the DLP fingerprints. Additionally, the cybersecurity solution or security enforcement point that generates the DLP fingerprints based on information received from a given cloud-native service or receives the DLP fingerprints from the cybersecurity solution or security enforcement point that generated the DLP fingerprints may further propagate the DLP fingerprints to one or more other security enforcement points, for example, via telemetry connections and/or API connections and such one or more other security enforcement points may perform DLP scanning based on the DLP fingerprints. For example, a firewall (e.g., one of firewall(s) 111) and/or an email security appliance (e.g., email security appliance 112) may receive DLP fingerprints generated based on information obtained from a cloud-native service by an intermediate security enforcement point (e.g., SASE or SSE platform 130) and may perform DLP scanning within an enterprise network (e.g., enterprise network 110) based on the DLP fingerprints.

While the examples described with reference to FIGS. 2-3 assume API-based CASB, it is to be appreciated the methodologies described herein are also relevant to inline-CASB functionality as well. For example, an endpoint may generate DLP fingerprints for one or more files at rest and may then sends them to the CASB platform or another security enforcement point directly. Alternatively, in the case of data in transit, the security enforcement point may generate the fingerprint itself as the user's traffic (the file) traverses the security enforcement point. As above, the administrative user may define what files at rest should be fingerprinted based on directories and the like. The administrator could also define what files in transit should be fingerprinted using inline-CASB functionality of the security enforcement point.

### Example DLP Scanning

FIG. 4 is a flow diagram illustrating a set of operations for performing DLP scanning in accordance with an embodiment of the present disclosure. The processing described with reference to FIG. 4 may be performed by a security enforcement point, for example, a SASE platform (e.g., SASE or SSE platform 130) or an SSE platform (e.g., SASE or SSE platform 130) that obtained DLP fingerprints generated based on information obtained from one or more cloud-native services (e.g., cloud-native service(s) 141) directly from a cybersecurity solution, for example, a CASB platform (e.g., CASB platform 150). Alternatively, or additionally, the processing described with reference to FIG. 4 may be performed by a security enforcement point, for example, a SASE platform (e.g., SASE or SSE platform 130), an SSE platform (e.g., SASE or SSE platform 130), or a network security appliance, for example, a firewall (e.g., one of firewall(s) 111) or an email security appliance (e.g., email security appliance 112) that obtained DLP fingerprints generated based on information obtained from one or more cloud-native services (e.g., cloud-native service(s) 141) indirectly from a cybersecurity solution, for example, a CASB platform (e.g., CASB platform 150) that may have generated the DLP fingerprints or caused them to be generated via an intermediate security enforcement point, for example, a SASE platform (e.g., SASE or SSE platform 130) or an SSE platform (e.g., SASE or SSE platform 130).

At decision block 410, a determination is made regarding the DLP scanning configuration of the security enforcement endpoint. If DLP scanning is to be performed on data in motion (e.g., as files are traversing the security endpoint), processing continues with block 420; otherwise, if DLP scanning is to be performed on data at rest, for example, files stored in one or more designated locations or protected endpoints (e.g., one or more files within a predefined or specified storage area of a cloud-native service, an enterprise user's computer system, and/or an on-premise file share), processing branches to block 430.

At block 420, DLP scanning is performed based on the currently available DLP fingerprints (e.g., DLP fingerprints 152), which are matched against one or more hashes of the contents of a file attempting to traverse the security enforcement point.

At block 430, DLP scanning is performed based on the currently available DLP fingerprints, which are matched against each file in the one or more designated locations or protected endpoints.

At decision block 440, it is determined whether a DLP fingerprint match was found (which may be referred to herein as a DLP violation). If so, processing continues with decision block 450; otherwise, if no DLP fingerprint matches were identified, processing loops back to decision block 410 for a next iteration.

At decision block 450, a determination is made regarding whether to block the file at issue. If the file is to be blocked, processing continues with block 460; otherwise, if the file is not to be blocked, processing branches to block 455.

At block 455, the file is allowed (i.e., is allowed to traverse the security enforcement point).

At block 460, the file is blocked (i.e., is not allowed to traverse the security enforcement point).

At decision block 470, a determination is made regarding whether to log the result of the DLP scanning. If so, processing continues with block 480; otherwise, processing branches to decision block 490.

At block 480, logging is performed. Depending on the particular implementation, the DLP violation/match/event may be logged locally by the security enforcement point and/or information regarding the DLP violation/match/event may be sent remotely by the security enforcement point, for example, over a protocol like syslog.

At decision block 490, a determination is made regarding whether to alerting is to be performed. If so, processing continues with block 495; otherwise, processing loops back to decision block 410.

At block 485, alerting is performed. For example, information regarding the DLP violation/match/event may be brought to the attention of the administrative user.

While in the context of the present example, the DLP scanning configuration is assumed to be either data in motion or data at rest, it is to be appreciated DLP scanning may be performed on both data in motion and data at rest, for example, in which DLP scanning of data in motion is performed in response to the security enforcement point observing a file is contained in traffic attempting to traverse the security enforcement point and in which DLP scanning of data at rest is performed on demand, responsive to expiration of a predetermined or configurable timer, and/or in response to determining a new file has been introduced to a designated location or a protected endpoint (e.g., a storage area of a cloud-native service, an enterprise user's computer system, and/or an on-premise file share). It is also to be noted that in some examples administrator-defined whitelisting/overrides/exceptions may be defined, for example, by an administrative user (e.g., admin 115), for example to override DLP matching and/or the associated actions (e.g., block, log, and/or alert) for certain files (e.g., file types, file names, and/or associated with particular metadata).

While in the context of the examples described with reference to the flow diagrams of FIGS. 2-4, a number of enumerated blocks are included, it is to be understood that examples may include additional blocks before, after, and/or in between the enumerated blocks. Similarly, in some examples, one or more of the enumerated blocks may be omitted and/or performed in a different order.

### Example Computer System

Embodiments of the present disclosure include various steps, which have been described above. The steps may be performed by hardware components or may be embodied in machine-executable instructions, which may be used to cause one or more processing resources (e.g., one or more general-purpose and/or special-purpose processors) programmed with the instructions to perform the steps. Alternatively, depending upon the particular implementation, various steps may be performed by a combination of hardware, software, firmware and/or by human operators.

Embodiments of the present disclosure may be provided as a computer program product, which may include a non-transitory machine-readable storage medium embodying thereon instructions, which may be used to program a computer (or other electronic devices) to perform a process. The machine-readable medium may include, but is not limited to, fixed (hard) drives, magnetic tape, floppy diskettes, optical disks, compact disc read-only memories (CD-ROMs), and magneto-optical disks, semiconductor memories, such as ROMs, PROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware).

Various methods described herein may be practiced by combining one or more non-transitory machine-readable storage media containing the code according to embodiments of the present disclosure with appropriate special purpose or standard computer hardware to execute the code contained therein. An apparatus for practicing various embodiments of the present disclosure may involve one or more computers (e.g., physical and/or virtual servers, physical and/or virtual network security appliances) (or one or more processors within a single computer) and storage systems containing or having network access to computer program(s) coded in accordance with various methods described herein, and the method steps associated with embodiments of the present disclosure may be accomplished by modules, routines, subroutines, or subparts of a computer program product.

FIG. 5 is a block diagram that illustrates a computer system 500 in which or with which an embodiment of the present disclosure may be implemented. Computer system 500 may be representative of computing resources associated with a cloud environment of a cloud provider (e.g., one of cloud providers 140), associated with a SASE or SSE platform (e.g., SASE or SSE platform 130), associated with a cybersecurity solution (e.g., CASB platform 150), associated with a network security appliance (e.g., one of firewall(s) 111 or email security appliance 112). Notably, components of computer system 500 described herein are meant only to exemplify various possibilities. In no way should example computer system 500 limit the scope of the present disclosure. In the context of the present example, computer system 500 includes a bus 502 or other communication mechanism for communicating information, and one or more processing resources (e.g., one or more hardware processors 504) coupled with bus 502 for processing information. Hardware processors 504 may include, for example, one or more general purpose microprocessors available from one or more current or future microprocessor manufactures (e.g., Intel Corporation, Advanced Micro Devices, Inc., and/or the like) and/or one or more special purpose processors (e.g., CPs, NPs, and/or accelerators or co-processors). In some examples, the one or more processing resources may be part of an ASIC-based security processing unit (e.g., the FORTISP family of security processing units available from Fortinet, Inc. of Sunnyvale, CA).

Computer system 500 also includes a main memory 506, such as a random access memory (RAM) or other dynamic storage device, coupled to bus 502 for storing information and instructions to be executed by processor(s) 504. Main memory 506 also may be used for storing temporary variables or other intermediate information during execution of instructions to be executed by processor(s) 504. Such instructions, when stored in non-transitory storage media accessible to processor(s) 504, render computer system 500 into a special-purpose machine that is customized to perform the operations specified in the instructions.

Computer system 500 further includes a read only memory (ROM) 508 or other static storage device coupled to bus 502 for storing static information and instructions for processor(s) 504. A storage device 510, e.g., a magnetic disk, optical disk or flash disk (made of flash memory chips), is provided and coupled to bus 502 for storing information and instructions.

Computer system 500 may be coupled via bus 502 to a display 512, e.g., a cathode ray tube (CRT), Liquid Crystal Display (LCD), Organic Light-Emitting Diode Display (OLED), Digital Light Processing Display (DLP) or the like, for displaying information to a computer user. An input device 514, including alphanumeric and other keys, is coupled to bus 502 for communicating information and command selections to processor(s) 504. Another type of user input device is cursor control 516, such as a mouse, a trackball, a trackpad, or cursor direction keys for communicating direction information and command selections to processor(s) 504 and for controlling cursor movement on display 512. This input device typically has two degrees of freedom in two axes, a first axis (e.g., x) and a second axis (e.g., y), that allows the device to specify positions in a plane.

Removable storage media 540 can be any kind of external storage media, including, but not limited to, hard-drives, floppy drives, IOMEGA® Zip Drives, Compact Disc-Read Only Memory (CD-ROM), Compact Disc-Re-Writable (CD-RW), Digital Video Disk-Read Only Memory (DVD-ROM), USB flash drives and the like.

Computer system 500 may implement the techniques described herein using customized hard-wired logic, one or more ASICs or FPGAs, firmware or program logic which in combination with the computer system causes or programs computer system 500 to be a special-purpose machine. According to one embodiment, the techniques herein are performed by computer system 500 in response to processor(s) 504 executing one or more sequences of one or more instructions contained in main memory 506. Such instructions may be read into main memory 506 from another storage medium, such as storage device 510. Execution of the sequences of instructions contained in main memory 506 causes processor(s) 504 to perform the process steps described herein. In alternative embodiments, hard-wired circuitry may be used in place of or in combination with software instructions.

The term “storage media” as used herein refers to any non-transitory media that store data or instructions that cause a machine to operation in a specific fashion. Such storage media may comprise non-volatile media or volatile media. Non-volatile media includes, for example, optical, magnetic or flash disks, such as storage device 510. Volatile media includes dynamic memory, such as main memory 506. Common forms of storage media include, for example, a flexible disk, a hard disk, a solid state drive, a magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 502. Transmission media can also take the form of acoustic or light waves, such as those generated during radio-wave and infra-red data communications.

Various forms of media may be involved in carrying one or more sequences of one or more instructions to processor(s) 504 for execution. For example, the instructions may initially be carried on a magnetic disk or solid state drive of a remote computer. The remote computer can load the instructions into its dynamic memory and send the instructions over a telephone line using a modem. A modem local to computer system 500 can receive the data on the telephone line and use an infra-red transmitter to convert the data to an infra-red signal. An infra-red detector can receive the data carried in the infra-red signal and appropriate circuitry can place the data on bus 502. Bus 502 carries the data to main memory 506, from which processor(s) 504 retrieve and execute the instructions. The instructions received by main memory 506 may optionally be stored on storage device 510 either before or after execution by processor(s) 504.

Computer system 500 also includes a communication interface 518 coupled to bus 502. Communication interface 518 provides a two-way data communication coupling to a network link 520 that is connected to a local network 522. For example, communication interface 518 may be an integrated services digital network (ISDN) card, cable modem, satellite modem, or a modem to provide a data communication connection to a corresponding type of telephone line. As another example, communication interface 518 may be a local area network (LAN) card to provide a data communication connection to a compatible LAN. Wireless links may also be implemented. In any such implementation, communication interface 518 sends and receives electrical, electromagnetic or optical signals that carry digital data streams representing various types of information.

Network link 520 typically provides data communication through one or more networks to other data devices. For example, network link 520 may provide a connection through local network 522 to a host computer 524 or to data equipment operated by an Internet Service Provider (ISP) 526. ISP 526 in turn provides data communication services through the world-wide packet data communication network now commonly referred to as the “Internet” 528. Local network 522 and Internet 528 both use electrical, electromagnetic or optical signals that carry digital data streams. The signals through the various networks and the signals on network link 520 and through communication interface 518, which carry the digital data to and from computer system 500, are example forms of transmission media.

Computer system 500 can send messages and receive data, including program code, through the network(s), network link 520 and communication interface 518. In the Internet example, a server 530 might transmit a requested code for an application program through Internet 528, ISP 526, local network 522 and communication interface 518. The received code may be executed by processor(s) 504 as it is received, or stored in storage device 510, or other non-volatile storage for later execution.

All examples and illustrative references are non-limiting and should not be used to limit the applicability of the proposed approach to specific implementations and examples described herein and their equivalents. For simplicity, reference numbers may be repeated between various examples. This repetition is for clarity only and does not dictate a relationship between the respective examples. Finally, in view of this disclosure, particular features described in relation to one aspect or example may be applied to other disclosed aspects or examples of the disclosure, even though not specifically shown in the drawings or described in the text.

The foregoing outlines features of several examples so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the examples introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A security enforcement system comprising:
one or more processing resources; and
instructions that when executed by the one or more processing resources cause the security enforcement system to:
obtain a plurality of DLP fingerprints generated based on a set of files stored in a cloud-native service; and
perform, by a data loss prevention (DLP) service of the security enforcement system, DLP on a file based at least in part on the plurality of DLP fingerprints, wherein the file is at rest on an endpoint protected by the security enforcement system or in transit through the security enforcement point.

2. The security enforcement system of claim 1, wherein the plurality of DLP fingerprints are locally generated by the DLP service by accessing the set of the files via an application programming interface (API) exposed by the cloud-native service.

3. The security enforcement system of claim 1, wherein the plurality of DLP fingerprints are received by the security enforcement system directly from a cloud access security broker (CASB) or indirectly from the CASB via another security enforcement system, wherein the CASB is configurable to access the set of the files via an application programming interface (API) exposed by the cloud-native service and generate the plurality of DLP fingerprints.

4. The security enforcement system of claim 1, wherein the plurality of DLP fingerprints are received by the security enforcement system directly or indirectly from the cloud-native service.

5. The security enforcement system of claim 1, wherein the cloud-native service comprises infrastructure-as-a-service (IaaS), software-as-a-service (SaaS), platform-as-a-service (PaaS), or container-as-a-service (CaaS).

6. The security enforcement system of claim 5, wherein the IaaS comprises an object storage service.

7. The security enforcement system of claim 5, wherein the SaaS comprises a file hosting service or a productivity platform.

8. The method of claim 1, wherein the security enforcement point comprises a security service edge (SSE) or a secure access service edge (SASE) platform.

9. A method comprising:
obtaining, by a security enforcement point that includes a data loss prevention (DLP) service, a plurality of DLP fingerprints generated based on a set of files stored in a cloud-native service; and
as a file is in transit through the security enforcement point from a first location to a second location, performing, by the DLP service, DLP on the file based at least in part on the plurality of DLP fingerprints before allowing the file to be transmitted to the second location.

10. The method of claim 9, wherein said obtaining comprises locally generating, by the DLP service, the plurality of DLP fingerprints by accessing the set of the files via an application programming interface (API) exposed by the cloud-native service.

11. The method of claim 9, wherein said obtaining comprises receiving, by the DLP service, the plurality of DLP fingerprints from a cloud access security broker (CASB), wherein the CASB is configurable to access the set of the files via an application programming interface (API) exposed by the cloud-native service and generate the plurality of DLP fingerprints.

12. The method of claim 9, wherein said obtaining comprises receiving, by the DLP service, the plurality of DLP fingerprints directly or indirectly from the cloud-native service.

13. The method of claim 9, wherein the cloud-native service comprises infrastructure-as-a-service (IaaS), software-as-a-service (SaaS), platform-as-a-service (PaaS), or container-as-a-service (CaaS).

14. The method of claim 9, wherein the security enforcement point comprises a security service edge (SSE).

15. The method of claim 9, wherein the security enforcement point comprises a secure access service edge (SASE) platform.

16. A non-transitory machine readable medium storing instructions, which when executed by one or more processing resources of a security enforcement system, cause the security enforcement system to:
obtain a plurality of DLP fingerprints generated based on a set of files stored in a cloud-native service; and
as a file is in transit through the security enforcement point from a first location to a second location, perform, by a DLP service of the security enforcement system, DLP on the file based at least in part on the plurality of DLP fingerprints before allowing the file to be transmitted to the second location.

17. The non-transitory machine readable medium of claim 16, wherein the plurality of DLP fingerprints are:
locally generated by the DLP service by accessing the set of the files via an application programming interface (API) exposed by the cloud-native service;
received by the security enforcement system directly from a cloud access security broker (CASB) or indirectly from the CASB via another security enforcement system, wherein the CASB is configurable to access the set of the files via an application programming interface (API) exposed by the cloud-native service and generate the plurality of DLP fingerprints; or
received by the security enforcement system directly or indirectly from the cloud-native service.

18. The non-transitory machine readable medium of claim 16, wherein the cloud-native service comprises infrastructure-as-a-service (IaaS), software-as-a-service (SaaS), platform-as-a-service (PaaS), or container-as-a-service (CaaS).

19. The non-transitory machine readable medium of claim 16, wherein the security enforcement point comprises a security service edge (SSE).

20. The non-transitory machine readable medium of claim 16, wherein the security enforcement point comprises a secure access service edge (SASE) platform.
